(19) United States
(12) Patent Application Publication
(10) Pub. No.: US 2025/0132487 A1
(43) Pub. Date: Apr. 24, 2025

(54) Multi-Band Conformal Slot Antennas and Related Devices

(71) Applicant: Sensus Spectrum, LLC, Morrisville, NC (US)

(72) Inventor: Zafarullah Khan, Kenner, LA (US)

(21) Appl. No.: 18/492,207

(22) Filed: Oct. 23, 2023

(51) Int. Cl. H01Q 1/22; G01D 4/00; H01Q 13/10

(52) U.S. Cl. CPC H01Q 1/2233; G01D 4/002; H01Q 13/10

(57) ABSTRACT

A multi-band conformal slot antenna is provided. The multi-band conformal slot antenna includes an antenna ground plane including two or more radiating slots of substantially equal length therein. The antenna ground plane has a length L and a width W of the antenna ground plane. The antenna ground plane includes a flexible material that bends into a form factor that allows the multi-band conformal slot antenna to be positioned in an enclosure that has a length less than the length L of the antenna ground plane.

### FIELD

The present inventive concept relates generally to antennas and, more particularly, to antennas suitable for use in small enclosures.

### BACKGROUND

Antennas are used in smart meters so meters can communicate with a remote location. For example, smart meters can measure customer usage of, for example, energy, water or gas, and transmit customer usage directly to the utility, possibly eliminating the practice of estimated bills. Thus, smart meters may provide near-real time usage information about how much, when and in some cases, at what price, a customer uses energy, water or gas. Smart meters work as a part of a smart grid and, therefore, provide improved outage detection and notification. Some smart meters can electronically report the location of outages before a call to the utility is made by a customer, making restoration faster and status notification much easier.

Having integrated antennas in the meter itself allows the meter to have this “smart” capability. However, as meters become smaller and more compact, providing an antenna with good efficiency that can operate in the required bandwidths in the smaller housing becomes a challenge.

### SUMMARY

Some embodiments of the present inventive concept provide a multi-band conformal slot antenna. The multi-band conformal slot antenna includes an antenna ground plane including two or more radiating slots of substantially equal length therein. The antenna ground plane has a length L and a width W of the antenna ground plan. The antenna ground plane may include a flexible material that bends into a form factor that allows the multi-band conformal slot antenna to be positioned in an enclosure that has a length less than the length L of the antenna ground plane.

In further embodiments, the form factor of the bent antenna ground plane may be substantially a “U” shape.

In still further embodiments, the multi-band conformal slot antenna may operate in two or more frequency bands.

In some embodiments, the length L of the antenna ground plane may be about 150 mm and the width W of the antenna ground plane may be about 57 mm.

In further embodiments, the flexible material may be a thin flexible copper clad laminate. In certain embodiments, a thickness of the thin flexible copper clad laminate may be about 0.16 mm.

In still further embodiments, the antenna may retain bandwidth and efficiency when bent.

In some embodiments, the multi-band conformal slot antenna may further include metal elements and the multi-band conformal slot antenna may retain bandwidth and efficiency when in close proximity to the metal elements. In certain embodiments, the metal elements may include a printed circuit board (PCB) and/or at least one battery.

In further embodiments, an edge E of the antenna ground plane may be extended a distance D beyond open ends of the two or more radiating slots.

Related smart meters are also provided herein.

### BRIEF DESCRIPTION OF THE DRAWINGS

FIG. 1 is diagram illustrating a ground plane of a multi-band conformal slot antenna assembly in accordance with some embodiments of the present inventive concept.

FIG. 2 is diagram illustrating an alternate ground plane of a multi-band conformal slot antenna assembly in accordance with some embodiments of the present inventive concept.

FIG. 3 is a diagram illustrating the ground plane of FIG. 1 or 2 bent into a smaller form factor in accordance with some embodiments of the present inventive concept.

FIG. 4 is a block diagram illustrating a meter including an enclosure including the antenna in accordance with some embodiments of the present inventive concept.

FIG. 5 is a more detailed diagram of a “U” shaped slot antenna positioned in an enclosure in accordance with some embodiments of the present inventive concept.

FIGS. 6A and 6B are graphs illustrating antenna efficiency and response, respectively, of embodiments illustrated in FIG. 5 in accordance with some embodiments of the present inventive concept.

FIGS. 7A and 7B are a diagram and graph, respectively, illustrating aspects of a conventional single slot antenna.

FIGS. 8A and 8B are a diagram and graph, respectively, illustrating aspects of a multi-slot antenna in accordance with some embodiments of the present inventive concept.

FIGS. 9A and 9B are a diagram and graph, respectively, illustrating aspects of a multi-slot antenna having a modified ground plane in accordance with some embodiments of the present inventive concept.

### DETAILED DESCRIPTION

The present inventive concept will be described more fully hereinafter with reference to the accompanying figures, in which embodiments of the inventive concept are shown. This inventive concept may, however, be embodied in many alternate forms and should not be construed as limited to the embodiments set forth herein.

Accordingly, while the inventive concept is susceptible to various modifications and alternative forms, specific embodiments thereof are shown by way of example in the drawings and will herein be described in detail. It should be understood, however, that there is no intent to limit the inventive concept to the particular forms disclosed, but on the contrary, the inventive concept is to cover all modifications, equivalents, and alternatives falling within the spirit and scope of the inventive concept as defined by the claims. Like numbers refer to like elements throughout the description of the figures.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises”, “comprising.” “includes” and/or “including” when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to another element, there are no intervening elements present. As used herein the term “and/or” includes any and all combinations of one or more of the associated listed items and may be abbreviated as “/”.

Unless otherwise defined, all terms (including technical and scientific terms) used herein have the same meaning as commonly understood by one of ordinary skill in the art to which this inventive concept belongs. It will be further understood that terms used herein should be interpreted as having a meaning that is consistent with their meaning in the context of this specification and the relevant art and will not be interpreted in an idealized or overly formal sense unless expressly so defined herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure. Although some of the diagrams include arrows on communication paths to show a primary direction of communication, it is to be understood that communication may occur in the opposite direction to the depicted arrows.

As discussed in the background, having integrated antennas in the meter itself allows the meter to have a “smart” capability. However, as meters become smaller and more compact, providing an antenna with good efficiency at low frequencies in a smaller housing becomes a challenge. For example, some meters require long term evolution (LTE) bands in the following ranges: 1710-1880 MHz; 880-960 MHz; 699-746 MHz; 791-832 MHz; and 703-803 MHz. In other words, coverage may be needed from 699-960 MHz and from 1710-1880 MHz for LTE.

Commercially available antennas that function in these ranges generally do not work well inside a small enclosure, for example, an enclosure smaller than 100 mm. For example, antennas having a dipole structure can radiate effectively at 699 MHz, but these antennas are generally over 200 mm. A 200 mm long antenna would not fit in the smaller enclosures that can only accommodate antennas less than 100 mm in length. Furthermore, enclosures containing electronics in meters generally also contain relatively large metal elements, such as batteries, e.g., a D-Cell battery or a Printed Circuit board (PCB) that runs the length and breadth of the enclosure. If a conventional dipole antenna were to be folded around such large metal elements, the dipole antenna would likely experience large drops in performance making them unsuitable for small enclosure applications.

Antennas having a monopole structure can be about half the length of a dipole antenna, but like dipole antennas, monopole antennas may suffer from large drops in performance when placed in close proximity to large, grounded metal elements.

Lengths of both dipole and monopole structures can be shortened by, for example, meandering or dielectric loading, but these techniques generally cause large reductions in efficiency and bandwidth, ultimately making these shortened versions of the dipole and monopole antennas unfit for covering the LTE bands at the desired efficiency. Furthermore, the close proximity of the metal elements, i.e., the PCB and large D-cell Lithium battery, may give rise to undesired near-field coupling effects that may result in further reduction of the bandwidth.

Accordingly, some embodiments of the present inventive concept provide a multi-band conformal slot antenna that operates within the ranges of 699-960 MHz and 1710-1880 MHz for LTE when housed with a relatively small enclosure and operates efficiently even when in close proximity to the metal elements within the enclosure. As used herein, “small enclosure” refers to an enclosure less than 100 mm in length. However, it will be understood that embodiments of the present inventive concept may be used in any size enclosure without departing from the scope of the present inventive concept.

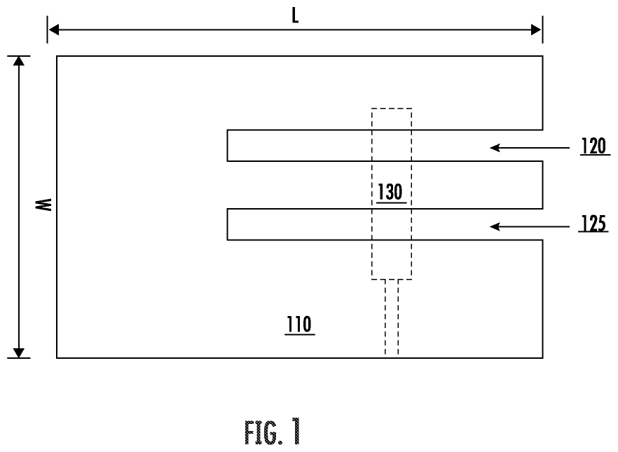

As used herein, “multi-band” refers to two or more frequency bands in which the antenna in accordance with embodiments of the present inventive concept operates. For example, in some embodiments a first frequency band may refer to 699-960 MHz and a second frequency band may refer to 1710-1880 MHz. However, embodiments of the present inventive concept are not limited thereto. For example, the antenna may operate in three or more different frequency bands without departing from the scope of the present inventive concept. Details of the multi-band conformal slot antenna in accordance with embodiments discussed herein will be discussed further below with respect to FIGS. 1 through 4.

As will be discussed below, the multi-band conformal slot antenna in accordance with embodiments discussed herein can be shaped into different “form factors” to enable the antenna to fit into more compact enclosures. For example, in some embodiments the antenna may be bent over itself into a “U” shape without significant impact to bandwidth and efficiency. It is understood that the “U” shape is provided as an example only and any form factor may be used without departing from the scope of the present inventive concept. Furthermore, unlike monopole and dipole antennas the conformal slot antenna discussed herein retains bandwidth and efficiency even when positioned in close proximity to metal elements, such as the PCB and large D cell Lithium battery.

Referring first to FIG. 1, a ground plane 110 for a multi-band slot antenna in accordance with some embodiments of the present inventive concept will be discussed. The ground plane is made of a thin flexible material. As used herein, “flexible material” refers to a material that can be bent into a shape and maintain that shape. For example, in some embodiments, the flexible material may be a flexible copper clad laminate. The entire antenna may be fabricated using the flexible material to facilitate bending to fit into tight spaces. The ground plane 110 is generally relatively thin, for example, in some embodiments about. 16 mm. As illustrated, the ground plane 110 has a length L and a width W. The length L is usually longer than the width W and, in some embodiments, the length L may be two or more times longer than the width W. In some embodiments, the ground plane bas a length L of 150 mm and a width W of 57 mm, where the length L is almost three times as long as the width W. However, embodiments of the present inventive concept are not limited thereto.

As further illustrated in the embodiments of FIG. 1, the ground plane 110 has two radiating slots 120 and 125. The two radiating slots may be of about equal length in some embodiments. It will be understood that the slots 120 and 125 do not have to be exactly the same length. These slots 120 and 125 have a quarter wavelength resonance at a lower band and the upper band response is achieved by a higher order resonance. As further illustrated, a microstrip feed 130 having an associated impedance is provided on an opposite surface of the ground plane 110 as indicated by the dotted lines.

The two slots 120 and 125, having a similar length in the illustrated embodiment, are excited by the microstrip 130 to resonate at fundamental and third harmonic frequencies. Thus, the effective length of the slots are adjusted so that the quarter wavelength resonance covers the lower band (e.g., 699 to 960 MHz) and the three quarter wavelength resonance covers the higher band (e.g., 1710 to 1880 MHz). Although the lower band is referred to as 699-960 MHz herein and the higher band is referred to as 1710-1880 MHz herein, embodiments of the present inventive concept are not limited thereto. These bands may be adjusted without departing from the scope of the present inventive concept.

The two slot embodiment illustrated in FIG. 1 differs from conventional multi-band slot antennas that use two or more slots of different lengths. In these conventional slot antennas, the longer slot length is adjusted to resonate over a low frequency band while the shorter slot length is adjusted to resonate over a higher frequency band. This generally results in a narrow bandwidth for the lower band making it difficult for these antennas to operate over the entire 699 MHz-960 MHz range. Thus, embodiments of the present inventive concept provide two or more slots of approximately equal length in the ground plane, thereby efficiently operating in both the lower and upper bands discussed herein.

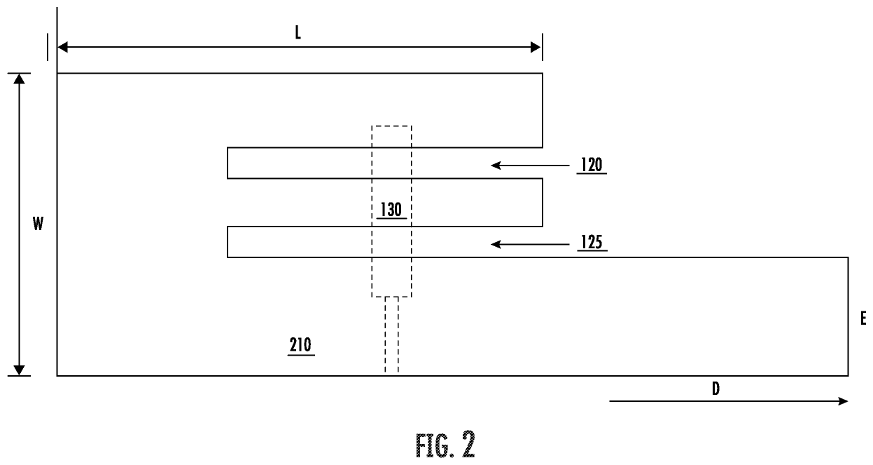

Referring now to FIG. 2, an alternate ground plane 210 in accordance with some embodiments of the present inventive concept will be discussed. The ground plane 210 is similar to the ground plane 110 discussed above with respect to FIG. 1. Like reference numerals refer to like elements throughout. However, in embodiments illustrated in FIG. 2, the edge E of the ground plane 210 is extended a distance D beyond the open end of the slots 120 and 125. Extension of the edge E allows control of the lower and upper edge of the low band as well as the maximum Voltage Standing Wave Ratio within the low and High band. In some embodiments, the distance D may be about 35 mm from the open end of the slots 120 and 125. However, it will be understood that embodiments of the present inventive concept are not limited thereto.

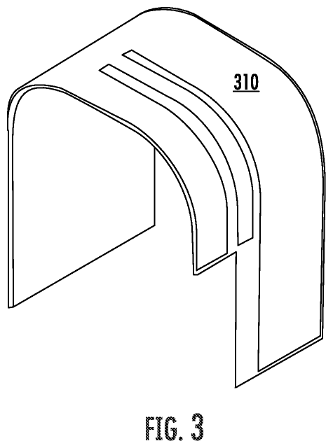

As discussed above, antennas in accordance with embodiments discussed herein may be positioned in various form factors to make the antenna fit into small enclosures. A specific embodiment of this concept is illustrated in FIG. 3. As illustrated in FIG. 3, the antennas including a ground plane (110 or 210) is bent into a “U” shaped configuration. As illustrated in FIG. 3, the ground plane 310, which could be ground planes 110 or 210 discussed above or with respect to FIGS. 1 and 2, respectively, is bent into a “U” shape so that it can fit into a smaller enclosure. Further embodiments of a ground plane may also be used. In particular, bending the ground plane 310 into a “U”-Shape allows the antenna to fit inside tight spaces with little to no degradation in performance. This is largely true even if there are electrically conductive surfaces within the U-Shape, such as PCBs, batteries and the like. It will be understood that although FIG. 3 illustrates the ground plane being bent into a “U” shape, embodiments of the present inventive concept are not limited to this configuration. The ground plane may be bent into other shapes than the U-shaped configuration.

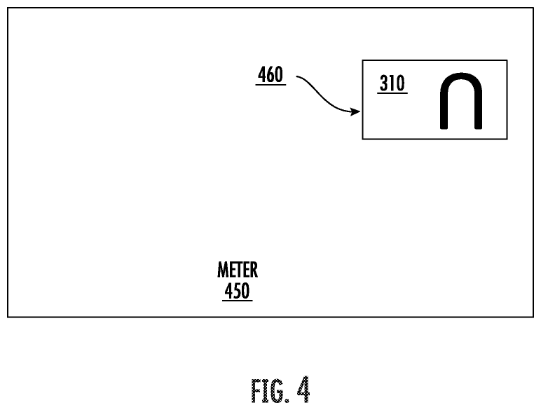

As discussed above, the multi-band conformal slot antenna in accordance with embodiments discussed herein may be used for communications to and from a smart meter. As illustrated in FIG. 4, the antenna including the “U” shaped ground plane 310 may be provided inside an enclosure 460 of a meter 450. The enclosure 460 may be limited in size due to the downsizing of equipment. For example, the enclosure 460 may be less than 100 mm long in some embodiments. Thus, embodiments of the present inventive concept allow the antenna ground plane 110 and 210 to form a “U” shape inside the enclosure 460, thus, allowing a large antenna to fit in a small enclosure. Unlike a monopole or dipole structure, multi-band conformal slot antennas in accordance with embodiments discussed herein retain bandwidth and efficiency even when bent into, for example, a U shape. Furthermore, the multi-band conformal slot antenna discussed herein retains bandwidth and efficiency even when it is in close proximity to metal elements, such as the PCB and large D cell Lithium battery.

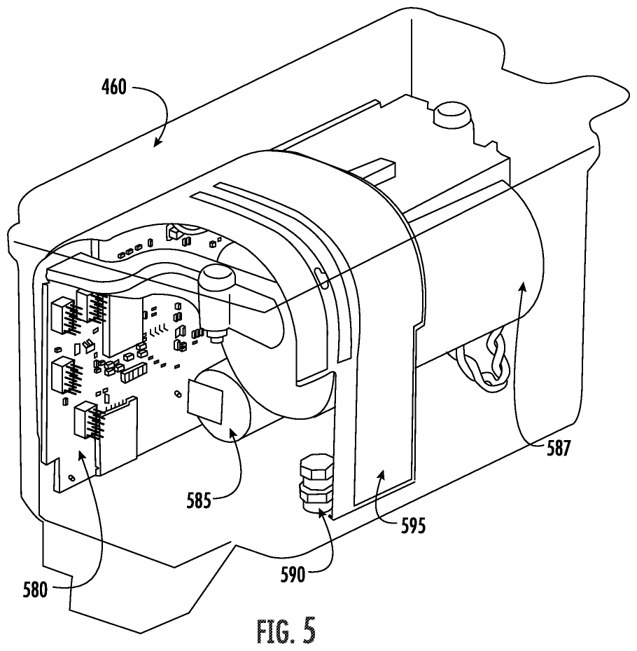

Referring now to FIG. 5, a more detailed diagram of the multi-band slot antenna positioned in an enclosure in accordance with embodiments discussed herein will be discussed. As illustrated in FIG. 5, the multi-band slot antenna 595 is in a “U” shaped and is wrapped around the components inside the device enclosure 460. The enclosure 460 may be limited in size due to the downsizing of equipment. For example, the enclosure 460 may be less than 100 mm long in some embodiments. Thus, embodiments of the present inventive concept allow the slot antenna 595 to form a “U” shape inside the enclosure 460, allowing a large antenna to fit in a small enclosure. As further illustrated, the enclosure 460 includes a printed circuit board included mounted components 580, an AA cell lithium battery 585, a large D Cell Lithium Battery 587 and a larger metal screw 590. The multi-band conformal slot antenna 595 retains bandwidth and efficiency even when bent into the U shape even when it is in close proximity to metal elements, such as the PCB 580, batteries 585 and 587 and the large metal screw 590.

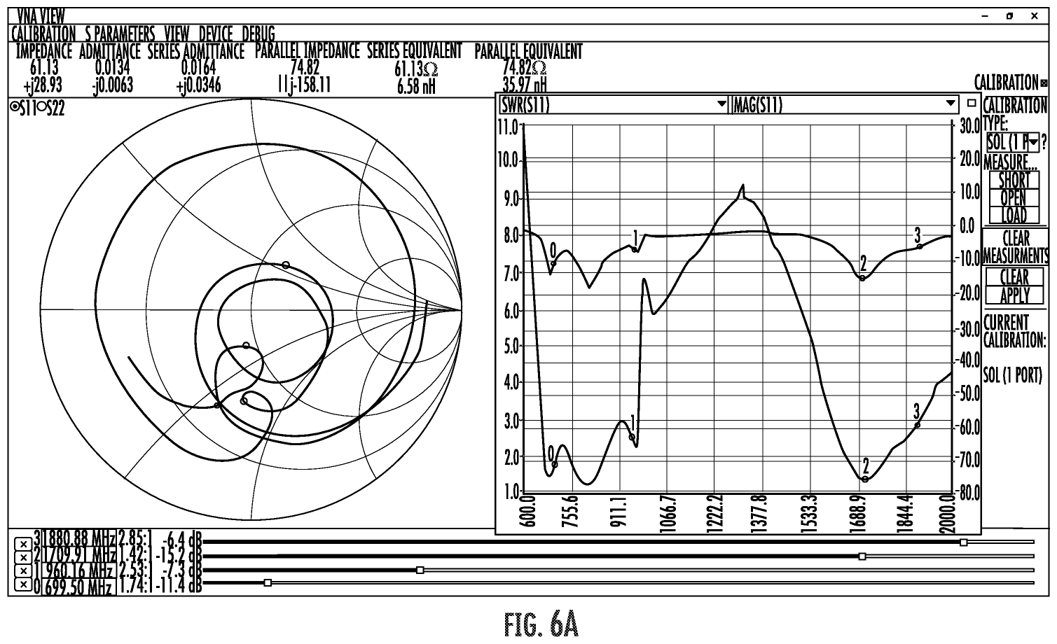

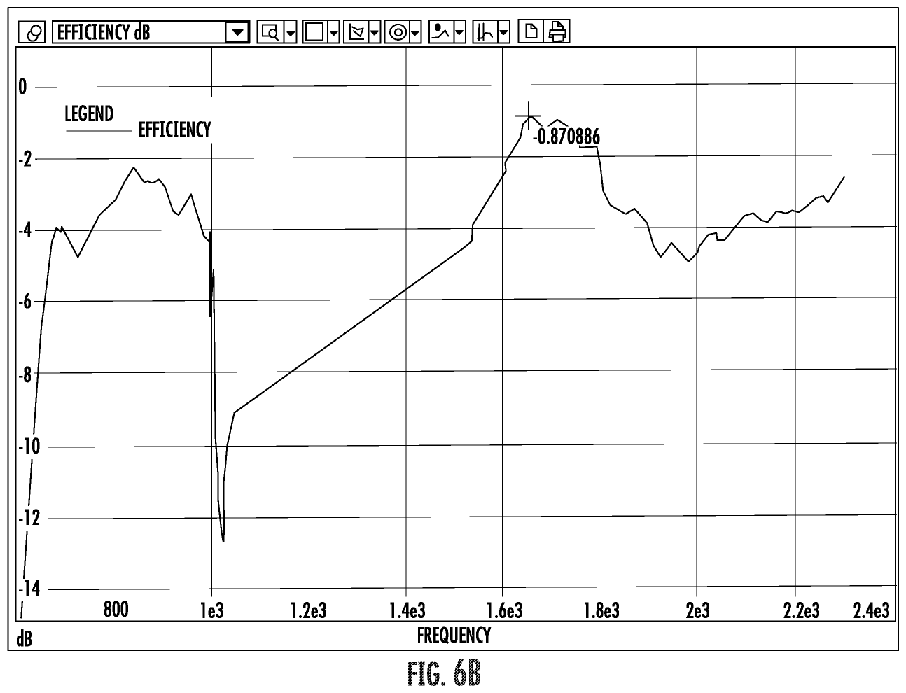

Referring now to FIGS. 6A and 6B, graphs illustrating response curves for the multi-band slot antenna in accordance with some embodiments of the present inventive concept are illustrated. In particular, the response curves of FIGS. 6A and 6B illustrate the antenna response when the antenna is bent into a “U” shape in accordance with some embodiments of the present inventive concept.

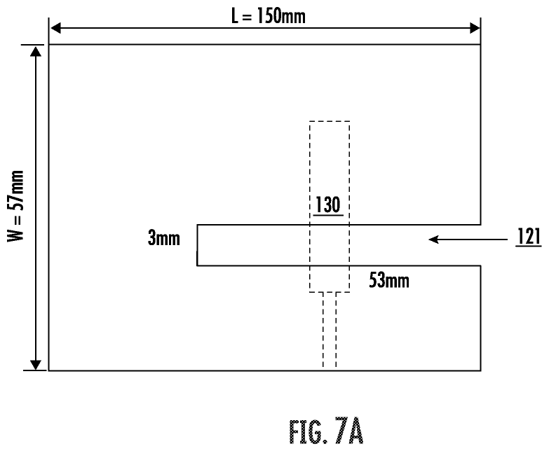

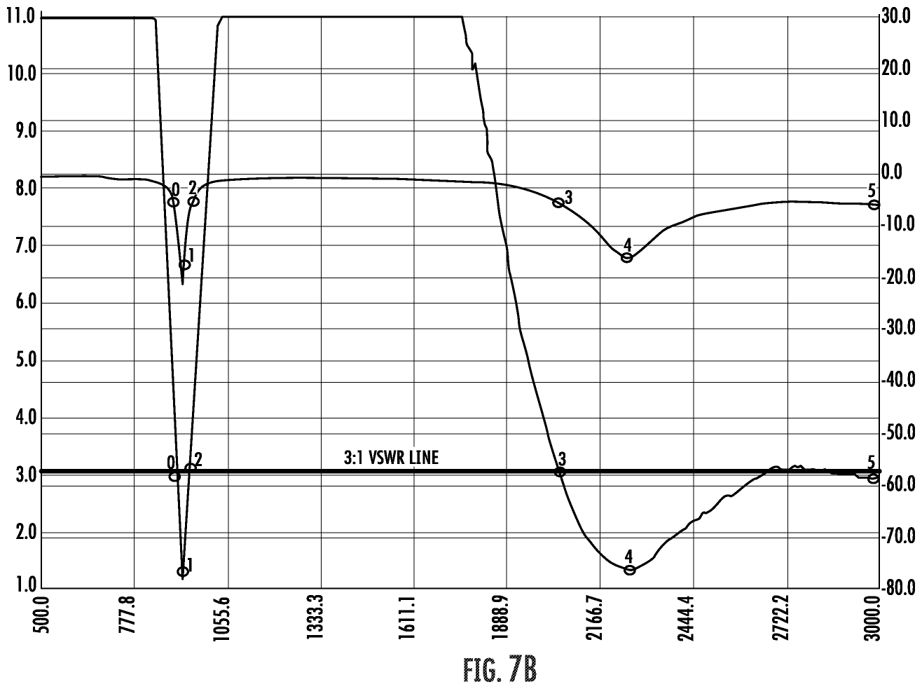

Various embodiments and results associated therewith will be discussed with respect to FIGS. 7A through 9B below. Referring first to FIGS. 7A and 7B, a diagram of a conventional slot antenna in a rectangular ground plane (7A) and a related graph (7B) will be discussed. As illustrated in FIG. 7B, the first resonance (marker 1) is very narrowband (only about 50 MHz) and the second resonance (marker 4) is broadband (almost a GHz) and is useful.

In particular, FIG. 7A illustrates a conventional dual band single slot antenna. In particular, the slot antenna of FIG. 7A bas a rectangular ground plane measuring 150 mm in length (L) and 57 mm in width (W). The single slot 121 has a width of 3 mm and a length of 53 mm. These dimensions are provided for example only. This conventional dual band single slot antenna has a very narrow bandwidth at its lower band. The antenna has a 3:1 VSWR (FIG. 7B) bandwidth of the low band of only about 50 MHz and extends from 895.79 MHz to 950.9 MHz. The high band (third order) response has a much better bandwidth of more than 955 MHz and extends from 2043.09 MHz to beyond 3 GHz.

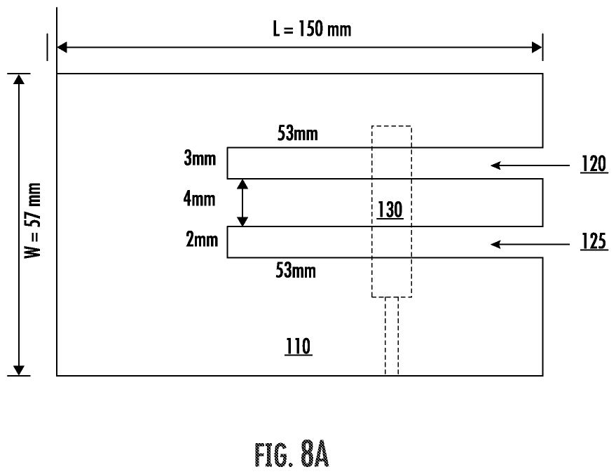

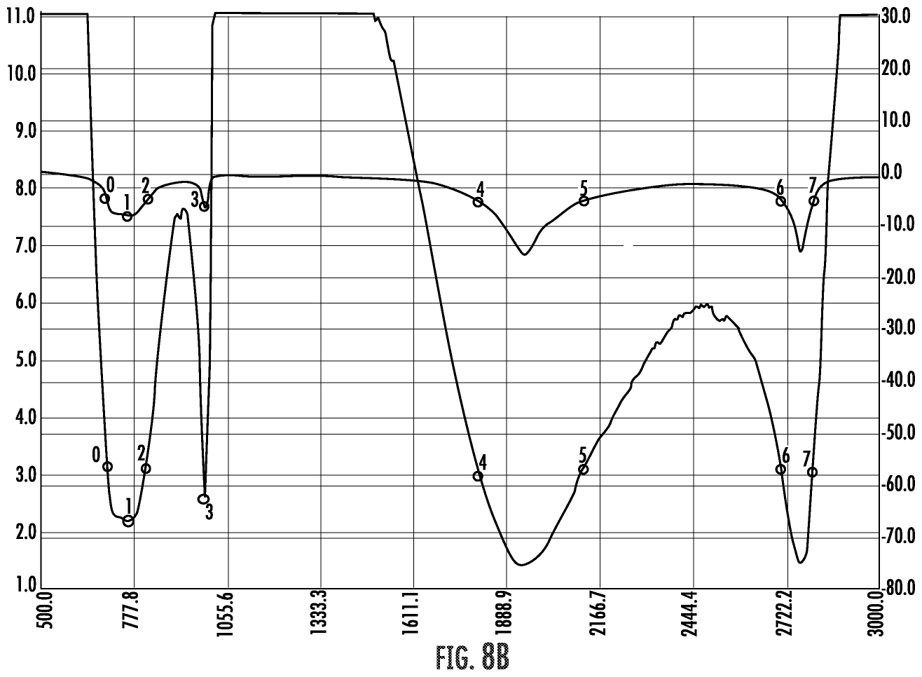

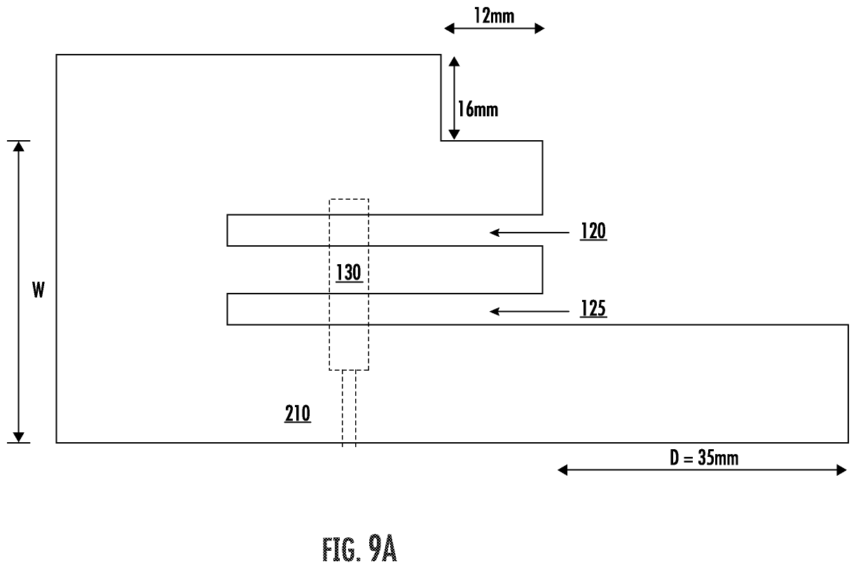

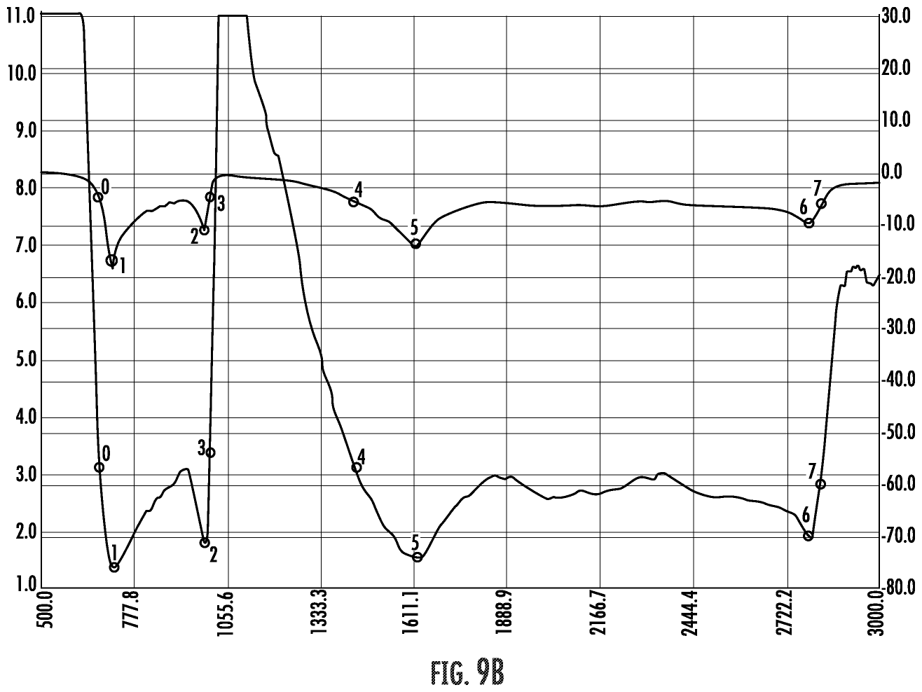

Embodiments of the present inventive concept provide multi-slot antennas having multiple parallel slots that provide an improved low band response, for example, with two parallel slots. FIGS. 6A and 6B illustrate double slot embodiments in accordance with some embodiments of the present inventive concept. In particular, the double slot antenna of FIG. 8A has a rectangular ground plane 110 measuring 150 mm in length (L) and 57 mm in width (W). The first slot 120 has a width of 3 mm and a length of 53 mm and the second slot 125 has a width of 2 mm and a length of 53 mm. These dimensions are provided for example only and embodiments are not limited thereto. As illustrated in FIG. 8B, the addition of a second parallel slot widens the first resonance to 120 MHz, and the low band now has two resonances close together. The first one is denoted by markers 0, 1 and 2 in FIG. 8B while the second (new) low band resonance is denoted by marker 3. The high band shows the corresponding third order resonances denoted by markers 4, 5 and 6, 7. Thus, the bandwidth of the low band has improved from 50 MHz to 120 MHz.

Furthermore, FIG. 8A illustrates a ground plane of an antenna having two parallel slots that provide improved 3:1 VSWR (FIG. 8B) bandwidth for the low band 700.4 MHz to 820.64 MHz, a bandwidth of 120 MHz. A second low band resonance now appears at 995.99 MHz. The third order response continues to be broadband with the high band covering from 1807.62 MHz to 2123.25 MHz and a second resonance appears from 2709.42 MHz to 2804.61 MHz for a bandwidth of 315 MHz and 95 MHz, respectively.

As will be discussed further below, the bandwidth can be further improved by making modifications to the ground plane 110 that may result in the two low band resonances combining to form a single very wideband resonance. The same effect may be exhibited in the high band where the two discrete resonances combine to form a large wideband resonance.

In particular, the result of modifying the shape of the ground plane, for example, is illustrated in FIGS. 9A and 9B. The two-slot antenna of FIGS. 6A and 6B is altered by shaping the rectangular ground plane near the open end of the slots. In particular, as shown, the length is extended 35 mm beneath the slots and a portion of the ground plan measuring 16 mm by 12 mm is removed above the slots. This modification causes the dual resonances in the low band to merge and form one broadband response. The dual resonances in the upper band also merge to form a broadband response. It will be understood that FIGS. 9A and 9B provide an example of some modifications to the ground plane; however, embodiments are not limited thereto.

The two discrete resonances in the low band have combined to form a very wideband resonance and the low band now has a bandwidth of 330 MHz up from 120 MHz provided by having a rectangular ground plane. The two discrete resonances in the high band also combine to form a single wide resonance with a bandwidth of 1383 MHz. This antenna therefore covers the following bands:
LTE band 3:1710-1880 MHz
LTE band 8:880 MHz-960 MHz
LTE band 12:699-746 MHz
LTE band 20:791-832 MHz
LTE band 28:703-803 MHz
   In addition, the antenna illustrated in FIGS. 9A and 9B also covers the 2.4 GHz WiFi bands. Thus, the antenna having the modification of the ground plane provides some improvement over the antenna having the two slots illustrated in FIGS. 6A and 6B.

As briefly discussed above, some embodiments of the present inventive concept provide an antenna having a ground plane that includes a plurality of radiating slots of approximately a same length. The antenna ground plane may be long and narrow (150 mm×57 mm) but made of thin (0.16 mm) flexible copper clad laminate that can easily bend. This allows the antenna ground plane to form, for example, a “U” shape inside a relatively small enclosure thus allowing a large antenna to fit in a small enclosure. Unlike a monopole or dipole structure, this embodiments of the present inventive concept retain bandwidth and efficiency even when bent into a U shape. Furthermore, even when bent and in close proximity to metal elements, the antenna discussed herein retains bandwidth and efficiency.

In the drawings and specification, there have been disclosed exemplary embodiments of the inventive concept. However, many variations and modifications can be made to these embodiments without substantially departing from the principles of the present inventive concept. Accordingly, although specific terms are used, they are used in a generic and descriptive sense only and not for purposes of limitation, the scope of the inventive concept being defined by the following claims.

That which is claimed is:

1. A multi-band conformal slot antenna comprising:
an antenna ground plane including two or more radiating slots of substantially equal length therein,
wherein the antenna ground plane has a length L and a width W of the antenna ground plane; and
wherein the antenna ground plane comprises a flexible material that bends into a form factor that allows the multi-band conformal slot antenna to be positioned in an enclosure that has a length less than the length L of the antenna ground plane.

2. The multi-band conformal slot antenna of claim 1, wherein the form factor of the bent antenna ground plane is substantially a “U” shape.

3. The multi-band conformal slot antenna of claim 1, wherein the multi-band conformal slot antenna operates in two or more frequency bands.

4. The multi-band conformal slot antenna of claim 1, wherein the length L of the antenna ground plane is about 150 mm and the width W of the antenna ground plane is about 57 mm.

5. The multi-band conformal slot antenna of claim 1, wherein the flexible material comprises a thin flexible copper clad laminate.

6. The multi-band conformal slot antenna of claim 5, wherein a thickness of the thin flexible copper clad laminate is about 0.16 mm.

7. The multi-band conformal slot antenna of claim 1, wherein the antenna retains bandwidth and efficiency when bent.

8. The multi-band conformal slot antenna of claim 1, wherein the multi-band conformal slot antenna further comprises metal elements and wherein the multi-band conformal slot antenna retains bandwidth and efficiency when in close proximity to the metal elements.

9. The multi-band conformal slot antenna of claim 8, wherein the metal elements comprise a printed circuit board (PCB) and/or at least one battery.

10. The multi-band conformal slot antenna of claim 1, wherein an edge E of the antenna ground plane is extended a distance D beyond open ends of the two or more radiating slots.

11. A smart meter comprising:
an enclosure that houses electronics associated with a communications circuit of the smart meter; and
a multi-band conformal slot antenna positioned in the enclosure, the multi-band conformal slot antenna comprising:
an antenna ground plane including two or more radiating slots of substantially equal length therein,
wherein the antenna ground plane has a length L and a width W of the antenna ground plane; and
wherein the antenna ground plane comprises a flexible material that bends into a form factor that allows the multi-band conformal slot antenna to be positioned in an enclosure that has a length less than the length L of the antenna ground plane.

12. The smart meter of claim 11, wherein the form factor of the bent antenna ground plane is substantially a “U” shape.

13. The smart meter of claim 11, wherein the multi-band conformal slot antenna operates in two more frequency bands.

14. The smart meter of claim 11, wherein the length L of the antenna ground plane is about 150 mm and the width W of the antenna ground plane is about 57 mm.

15. The smart meter of claim 11, wherein the flexible material comprises a thin flexible copper clad laminate.

16. The smart meter of claim 15, wherein a thickness of the thin flexible copper clad laminate is about 0.16 mm.

17. The smart meter of claim 11, wherein the antenna retains bandwidth and efficiency when bent.

18. The smart meter of claim 11, wherein the multi-band conformal slot antenna further comprises metal elements and wherein the multi-band conformal slot antenna retains bandwidth and efficiency when in close proximity to the metal elements.

19. The smart meter of claim 18, wherein the metal elements comprise a printed circuit board (PCB) and/or at least one battery.

20. The smart meter of claim 11, wherein an edge E of the antenna ground plane is extended a distance D beyond open ends of the two or more radiating slots.
